(19) United States
(12) Patent Application Publication
(10) Pub. No.: US 2002/0163422 A1
(43) Pub. Date: Nov. 7, 2002

(54) Service request communication system

(76) Inventor: William Eggers, New York, NY (US)

Correspondence Address: FRISHAUF, HOLTZ, GOODMAN, LANGER & CHICK, P.C., 25th Floor, 767 Third Avenue, New York, NY, 10017, US

(21) Appl. No.: 09/847,490

(22) Filed: May 2, 2001

(51) Int. Cl. H04Q 1/30

(52) U.S. Cl. 340/7.29; 340/5.9; 340/286.09

(57) ABSTRACT

A customer activated device for use by a customer in an establishment to provide an indication to service personnel that the customer desires service includes manually actuatable service requesters disposed at various locations within the establishment. Each of the plurality of manually actuatable service requesters includes a transmitter for transmitting, upon activation by a customer, a signal specific to the corresponding service requester. The device also includes a base station having a receiver and transmitter. The base station is electrically coupled to each of the manually actuatable service requesters and receives the signals transmitted by the manually actuatable service requesters and sends a service request signal in response thereto. The device further includes pagers electrically coupled to the base station. Each of the plurality of pagers is associated with at least one of the manually actuatable service requesters. At least one of the pagers receives the service request signal from the base station in response to actuation of a corresponding one of the manually actuatable service requesters.

### FIELD OF THE INVENTION

The present invention relates to communication systems, and more particularly to a service request communication system which enables an establishment to provide its customers a better way to communicate requests for service, and management a better way to coordinate employee work responsibilities thereby enabling a customer's service requests to be responded to more quickly and for the establishment to function more efficiently.

### BACKGROUND OF THE INVENTION

An ongoing issue at service-based business establishments such as restaurants, bars, entertainment venues, sports venues, retail merchandise stores and the like is the difficulty patrons have in advising a service provider of their need for service. For example, in restaurants and bars, customers may wish to order food, drinks, or pay the bill, in entertainment or sports venues, a patron may wish to order food, drinks or a souvenir, and in stores, a customer may need assistance in finding, selecting or purchasing an item.

The difficulty in advising service personnel of the need for service, and in the service personnel providing the requested service is especially problematic in establishments which have a high customer-to-server ratio. Not infrequently a patron must devote considerable time and effort to obtain the service provider's attention so as to elicit the necessary service. This detracts from the patron's experience in the establishment. If the patron is required to devote a great deal of time in order to contact the service personnel, they may become impatient or frustrated and instead decide to forego the purchase or potential purchase. Additionally, if the patron's request for service is not responded to within a time period that the patron deems acceptable, the patron may leave the establishment without making the purchase, may never return again because of the frustration felt by not receiving the necessary service, and may tell acquaintances and friends of the experience which will serve as a negative advertisement for the establishment. On the other hand if patrons are serviced quickly, then the number of persons who visit the establishment and the number of purchases made will increase which results in greater profits for the establishment.

Also, servicing customers expeditiously may allow an establishment to realize greater efficiencies in labor allocation thereby reducing costs and increasing profits.

Devices for signaling servers (i.e., wait staff) in restaurants and bars are known. One type of signaling device includes a portable indicator (lamps) placed on each table and which is illuminated or modified by a patron when service is desired. Examples of such a device are described in U.S. Pat. Nos. 5,828,294 to Shank; 5,594,409 to Shank; 4,250,491 to Dotson; 3,967,274 to Howell; and 3,558,871 to Rogers, the entire disclosures of which are incorporated herein by reference. One disadvantage of the portable indicators is that the server is not actively notified of the request for service and must continually scan the tables to see if the service light is illuminated indicating that service is requested.

Another type of signaling device is a permanently installed system that includes signal buttons at each table or seat electrically coupled to a panel or control unit which actively notifies the server. Systems of this type are detailed in U.S. Pat. Nos. 4,777,488 to Carlman, Jr. et al; 4,222,111 to Sloan et al; 3,821,707 to Peters; 5,699,039 to Korzen; and 3,810,164 to Lambert, the entire disclosures of which are incorporated herein by reference. These systems typically include complex permanent wiring and installation. Furthermore, these systems must be customized and do not lend themselves to relatively inexpensive, off-the-shelf sales by restaurant suppliers.

These prior art systems lack important features which have prevented them from gaining widespread acceptance in applicable industries and recognition as a means to increase revenues. Firstly, the prior art systems do not prioritize customer requests. The prior art systems typically only display the most recent location requesting service. Some provide a storage buffer to store previous service requests but do not, however, provide for a simultaneous display of multiple requests. At best, these systems require the server to manually scroll through the stored requests. In a busy establishment, it is reasonable to expect a worker using a service request system to receive multiple requests for service before being able to address the first request. Using one of the prior art systems, a worker must memorize the requests as they are received or must actively examine past requests by accessing the storage buffer.

Additionally, the prior art systems do not display the time of a customer's request in relation to the current time and therefore it is impossible for a service provider to know how long a customer has been waiting for a response. The prior art systems also do not provide a mechanism to properly handle multiple requests from a single location within a short period of time.

Moreover, these systems do not provide a method to easily change the assignment of customer-initiated devices (i.e., service request devices) and portable devices (i.e., pagers worn by service providers). In a busy establishment, it is common for location assignments (areas which a server is responsible) to change during the course of a business day and also to dynamically change during the course of normal business. In restaurants, for example, table assignments may differ for breakfast, lunch and dinner. They also may differ during peak and non-peak hours. Additionally, it is common for the wait staff to provide each other assistance or to periodically cover for one another during a break. Typical systems associate the customer-initiated devices and the portable devices in a way that makes changing assignments difficult or impossible. The inability to easily change service provider/customer initiated device assignments is a shortcoming of the existing prior art systems and a major barrier to widespread acceptance of these systems by business owners and business managers.

Even further, none of the prior art systems provide a mechanism for the supervisors and managers of the establishment to analyze the data associated with the service request system to: evaluate the responsiveness of the service providers to customer requests; determine staffing requirements; allocate service personnel; determine employee compensation and other management functions.

A non-permanent signaling device for communicating with a service provider could find wide application to assist in the allocation of workers, to improve customer satisfaction, to increase revenue by helping the customer obtain the desired service quickly to make a sale before the customer changes his mind, to increase revenue by helping the customer obtain the desired service quickly so that another customer can use the facility and purchase a product/service, and to encourage repeat business because the customer is satisfied with the service he received.

### OBJECTS AND SUMMARY OF THE INVENTION

It is therefore an object of the present invention to provide a communication system for indicating a desire for service at a particular location in an establishment.

It is also an object of the present invention to provide a service request communication system which displays multiple requests for service simultaneously.

It is another object of the present invention to provide a service request communication system which displays the time that each service request was made.

It is another object of the present invention to provide a service request communication system which displays the current time.

It is another object of the present invention to provide a service request communication system which prioritizes requests for service when multiple requests are received.

It is another object of the present invention to provide a service request communication system which includes a display for the service provider that displays multiple prioritized requests for service, the time that the service requests were placed, and the elapsed time since each service request was placed and the current time.

It is another object of the present invention to provide a system for monitoring the responsiveness of service personnel to a request for service.

It is yet another object of the present invention to overcome inherent disadvantages of known service request systems.

In accordance with one form of the present invention, a customer activated device for use by a customer in an establishment to provide an indication to service personnel that the customer desires assistance includes a plurality of manually actuatable service requesters disposed at a plurality of locations within the establishment. Each of the plurality of manually actuatuable service requesters includes a transmitter for transmitting at least one electronic signal, specific to the corresponding service requester, upon actuation by a customer. The electronic signal corresponds to a request for service. The device also includes a base station having a receiver and transmitter. The base station is electrically coupled to each of the plurality of manually actuatable service requesters for receiving the electric signals transmitted therefrom and for sending a service request signal in response thereto. The device also includes a plurality of remote communicators electrically coupled to the base station. The base station associates each of the plurality of remote communicators with at least one of the plurality of manually actuatable service requesters. At least one of the plurality of remote communicators receives the service request signal from the base station in response to actuation of a corresponding one of the plurality of manually actuatable service requesters. When a service request signal is received by one of the plurality of remote communicators, a service personnel associated with the corresponding remote communicator is made aware that service is requested by a corresponding one of the plurality of manually actuatable service requesters.

In accordance with another form of the present invention, a customer activated device for use by a customer in an establishment to provide an indication to service personnel that the customer desires assistance includes a plurality of manually actuatable service requesters disposed at a plurality of locations within the establishment. Each of the plurality of manually actuatable service requesters includes a transmitter for transmitting a service request signal specific to the corresponding service requester, upon actuation by a customer. The device also includes a plurality of remote communicators electrically coupled to the plurality of service requesters. Each of the plurality of remote communicators is associated with at least one of the plurality of manually actuatable service requesters. At least one of the plurality of remote communicators receives the service request signal from the service requester in response to actuation of a corresponding one of the plurality of manually actuatable service requesters. When a service request signal is received by one of the plurality of remote communicators, a service personnel associated with the corresponding remote communicator is made aware that service is requested by a corresponding one of the plurality of manually actuatable service requesters.

These and other objects, features and advantages of the present invention will become apparent to those skilled in the art from the following detailed description of illustrative embodiments thereof, which is to be read in connection with the accompanying drawings.

### BRIEF DESCRIPTION OF THE DRAWINGS

FIG. 1 is a functional block diagram of the service request communication system of the present invention;

FIG. 2 is a flow diagram of the functions performed by each manually actuatable service requester of the service request communication system;

FIG. 3 is a flow diagram of the method of service request operation of the base station of the service request communication system;

FIG. 4 is a flow diagram of the method of operation of each pager of the service request communication system;

FIG. 5 is a flow diagram of the method of operation of configuring various features of the base station; and

FIG. 6 is an alternative embodiment of the service request communication system of the present invention.

### DETAILED DESCRIPTION OF THE PREFERRED EMBODIMENT

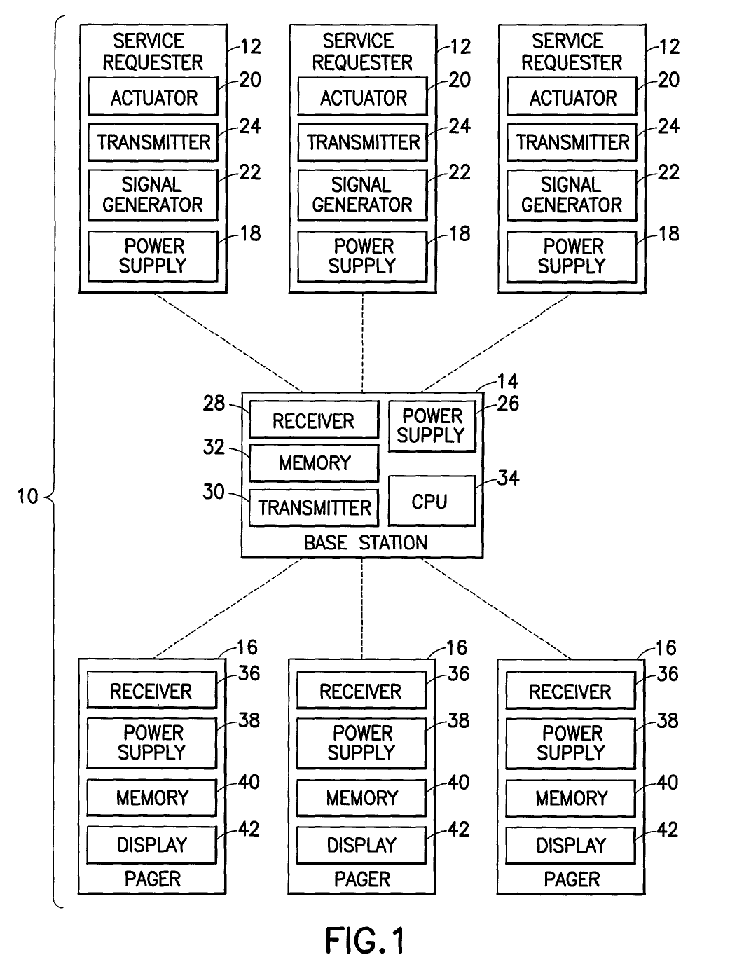

Referring now to FIG. 1 of the drawings, a functional block diagram of the service request communication system 10 of the present invention is shown. The system generally includes a plurality of manually actuatable service requesters 12, a base station 14, and a plurality of pagers (remote communicators) 16. Each of the plurality of service requesters is disposed at a specific location within an establishment where a patron might request service. For example, in a restaurant setting, the manually actuatable service requesters may be positioned at each table, at each seating location at the bar, and at various locations in a waiting area or lounge. Each service requester is designed to transmit an electronic signal (at least one electronic signal) which will be relayed to a pager worn by the service provider (i.e., wait staff or managers) who has been designated as providing service to that particular location of the establishment or is a manager (described in more detail below).

Each of the plurality of manually actuatable service requesters 12 includes a power supply 18 (such as a battery), and an actuator 20 such as a depressible button or buttons. When a customer desires the attention of the service provider, the customer depresses the actuator which causes a signal generator 22 to generate an electronic signal indicative of that particular service requester. The signal generator provides the generated signal to a transmitter 24 which transmits the generated signal for the base station 14. While any available frequency of signal transmission may be used, in the preferred embodiment a signal in the 900 mHz frequency range is utilized. While a button is mentioned as the actuator, any type of device capable of having two alternate states (on/off) may be employed.

The base station 14 of the present invention preferably includes a power supply 26, a receiver 28, a transmitter 30, a memory 32 and a central processing unit (CPU) 34. In a restaurant, the base station is preferably centrally located, and may be integrated with, a wait staff station. The base station receiver 28 is designed to receive the signals transmitted by each service requester 12. The CPU of the base station is programmed to differentiate the signals received from each service requester and to associate the received signal with a specific service requester and therefore a specific location within the establishment. In the preferred embodiment, upon receipt of a signal transmitted by a service requester, the base station accesses its memory (e.g., a look-up table) and determines which of the plurality of pagers 16 are associated with the particular service requester 12. Thereafter, the base station stores the request information (location within the establishment that is requesting service), including the time the request was made, in its memory 32 and transmits an electronic signal to each of the plurality of pagers associated with the service requester that transmitted the service request signal.

Each pager 16 of the present invention includes a receiver 36, power supply 38, memory 40, and display 42. In operation, the receiver 36 receives the transmitted signal sent by the base station 14 which is indicative of a request for service at a location within the establishment which has been assigned to the person associated with the pager. Upon receiving the signal from the base station, the pager stores the identification of the location requesting service along with the time of the request, and its priority and displays the information on the display. This information is also stored in the memory 32 of the base station. In one embodiment, the pager also displays the current time and the elapsed time since the request for service was made. The pager may also include a vibrating device or a sound transducer (not shown) which would provide a tactile or audible indication to the service provider that a signal corresponding to a request for service was received from the base station.

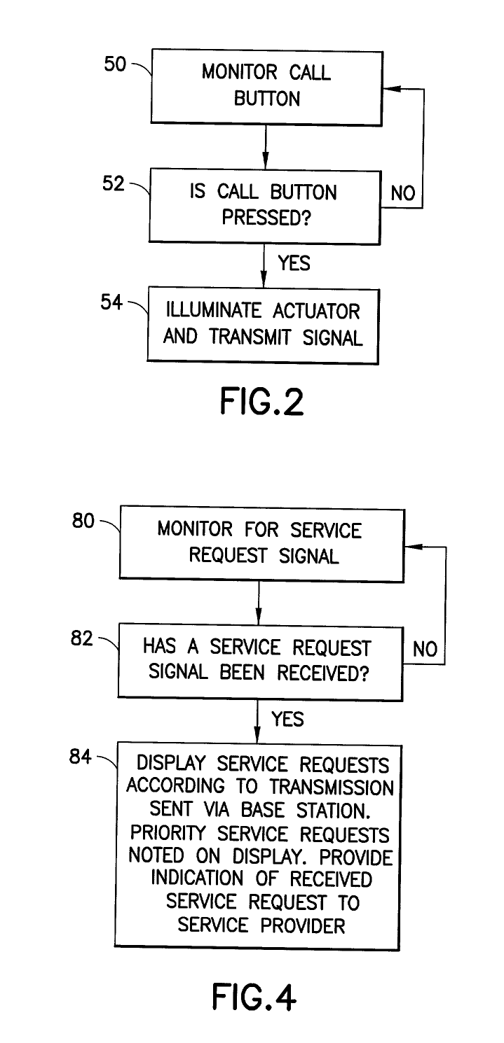

Referring now to FIG. 2, the method of operation of each manually actuatable service requester 12 is shown. Each service requester is maintained in a monitoring mode which monitors whether the call button 20 has been actuated by a customer (Step 50). A determination is then made as to whether the call button has been pressed (Step 52). If the call button has not been pressed (NO in Step 52), the method returns to Step 50. However, if the call button was pressed (YES in Step 52), then the call button is momentarily illuminated and the signal generator generates a signal which is transmitted by the transmitter to be received by the base station (Step 54).

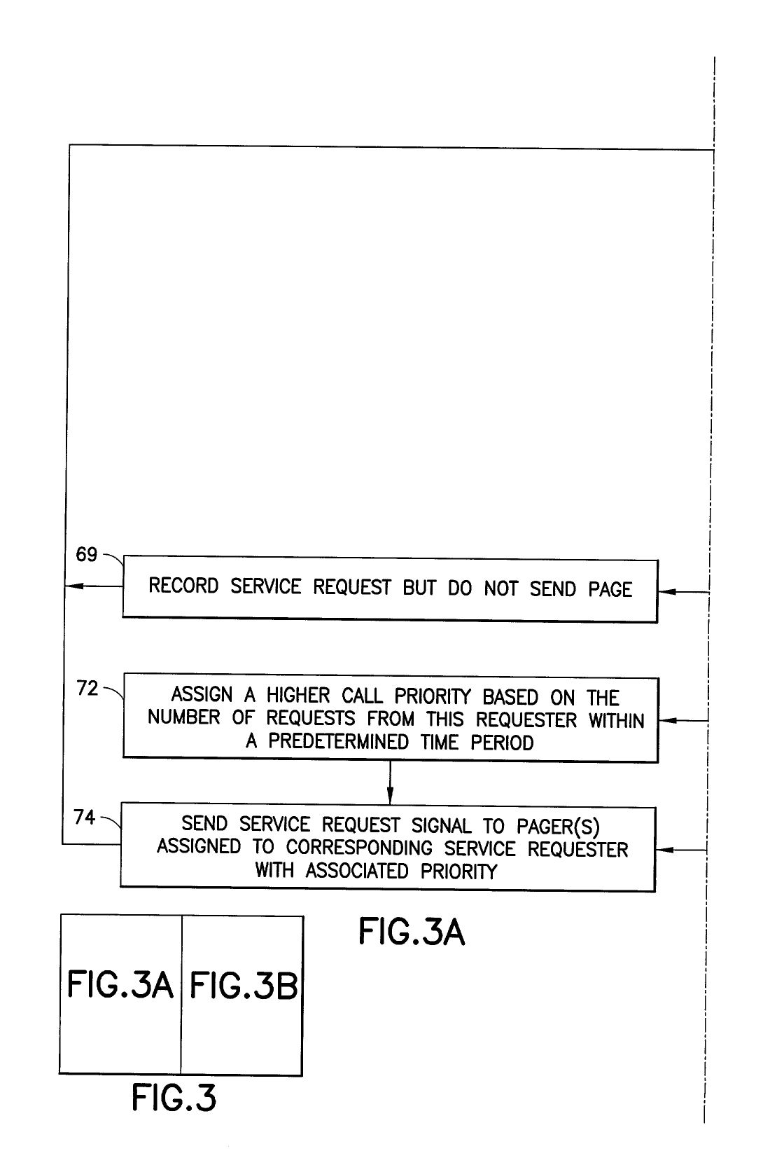

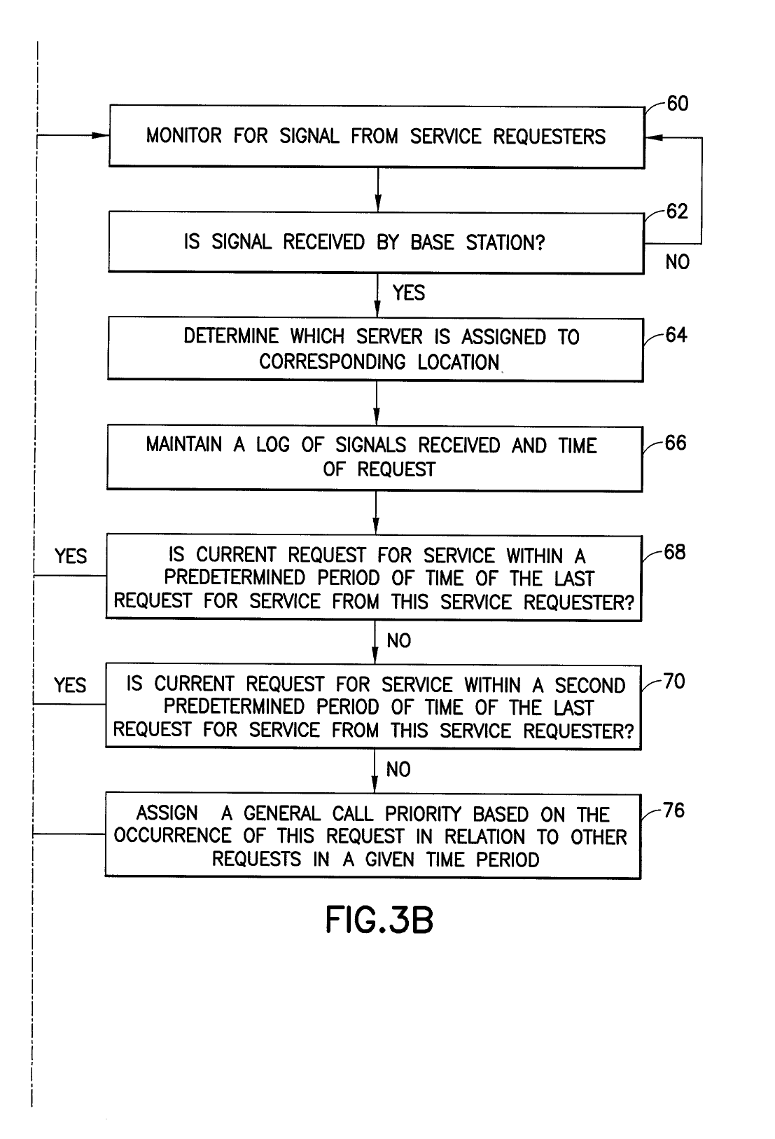

Referring now to FIG. 3, the method of operation of the base station 14 for interaction with the plurality of manually actuatable service requesters 12 and the plurality of pagers 16 is shown. Initially, the base station monitors the received signals for a call signal from one of the plurality of manually actuatable service requesters (Step 60). A determination is then made as to whether a signal has been received from one of the service requesters (Step 62). If a signal has not been received from one of the service requesters (NO in Step 62), then the method returns to Step 60. If a signal has been received from one of the service requesters (YES in Step 62), then a determination is made as to which pager is assigned to the service requester that transmitted the signal (Step 64). The base station then stores in its memory the information regarding the call signal and the time at which the request for service was placed (Step 66). A determination is then made as to whether the current service request of the specific service requester was received within a first predetermined period of time from the previous service request of the same service requester (Step 68).

In one embodiment of the prioritization scheme, if the current service request was received within the first predetermined period of time (e.g., 30 seconds) (YES in Step 68), then the request for service is recorded in memory, but a service request signal is not sent to the assigned pager (Step 69). The method then returns to Step 60. If the current service request was not received within the first predetermined period of time (NO in Step 68), then a determination is made as to whether the current service request of the specific service requester was received within a second predetermined period of time (e.g., 1 minute) (Step 70). If the current service request was received within the second predetermined period of time (YES in Step 70), then a higher call priority is assigned based on the number of requests from this requester within the predetermined periods of time (Step 72) and a service request is sent to the pager(s) assigned to the corresponding service requester with the associated priority (Step 74). If the current service request was not received within the second predetermined period of time (NO in Step 70) then a general call priority is assigned to the service request based on the occurrence of this request in relation to other service requests in a given time period (Step 76) and a service request signal is sent to the pager(s) assigned to the corresponding service requester with the associated priority (Step 74). The method then returns to Step 60.

The features outlined in Steps 69 and 76 are included to prevent the service providers from receiving too many paging signals from a particular location within a short period of time in the event that the service requester button is, for example, only being played with by a child or adolescent. Other embodiments of the prioritization scheme are foreseen.

Turning now to FIG. 4, the method of operation of each pager 16 is shown. The pager is typically in a monitoring mode so as to monitor for the receipt of a paging signal from the base station (Step 80). A determination is then made as to whether a paging signal is received (Step 82). If a paging signal is not received from the base station (NO in Step 82), then the method returns to Step 80. If a paging signal is received (YES in Step 82), then the information corresponding to the paging signal is displayed on the pager display and, in some embodiments, stored in the pager's memory (Step 84). If a priority page signal was received, then the priority page is noted on the display and given higher priority on the display which is clearly recognizable to the service provider. The pager may also vibrate, illuminate or emit an audible sound to indicate to the service provider that a request for service signal was received by the pager.

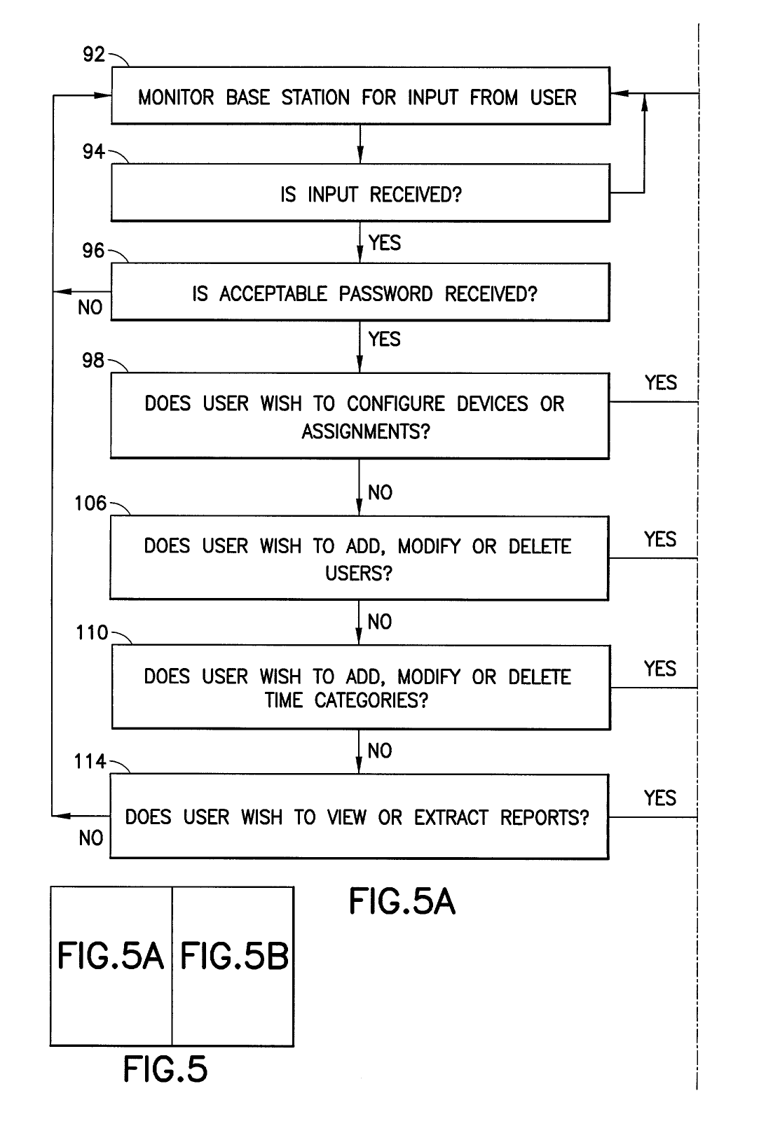

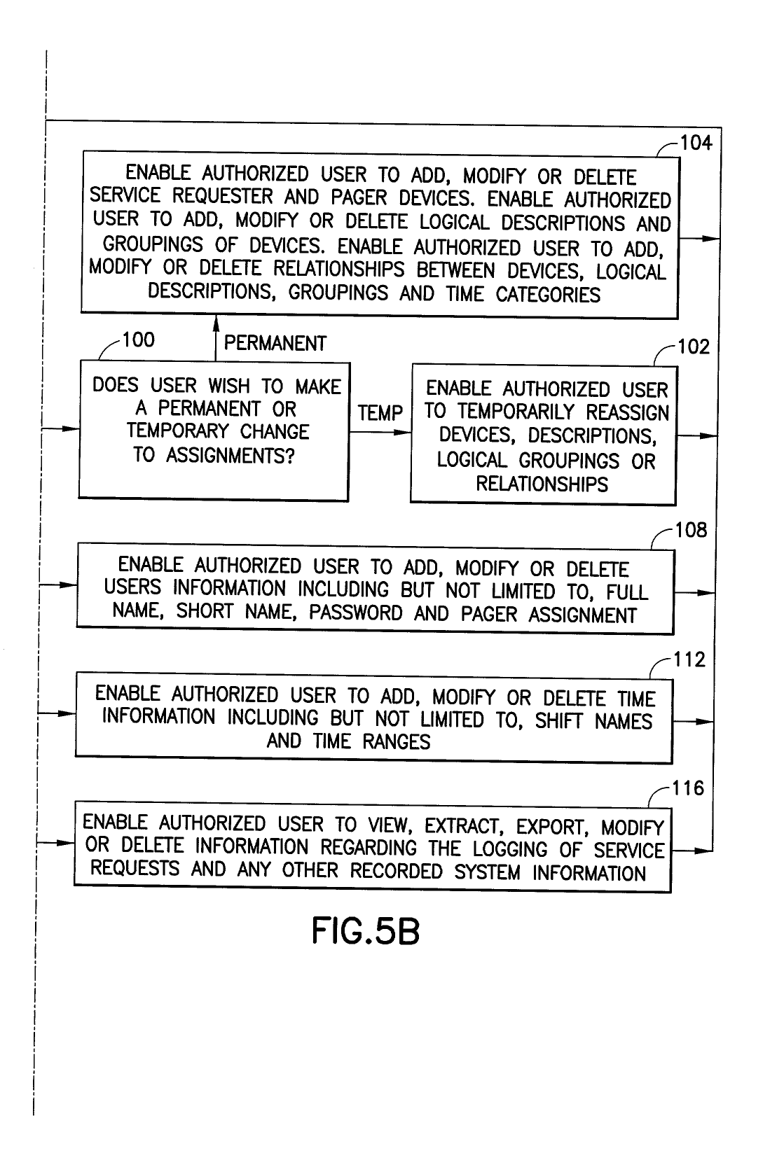

Referring now to FIG. 5, the method of employing the base station to allocate service providers to particular service requesters and for obtaining information regarding the number of service requests made by customers is shown. Initially, the base station is in a monitoring mode to monitor for a request from an authorized user to access information or to reallocate service providers/service requesters (Step 92). A determination is made as to whether a request for access to the base station has been received (Step 94). If a request has not been received (NO in Step 94), then the method returns to Step 92. If a request for access has been received (YES in Step 94), then the method proceeds to determine whether a correct pass code has been received (Step 96). If an acceptable pass code has not been received (NO in Step 96), then the method returns to Step 92. Alternatively a request for re-entry of the pass code can be made.

Once a correct pass code has been received (YES in Step 96), then a determination is made as to whether the authorized user would like to configure the service requesters and pagers or change the relationship between service requesters and pagers or table assignments of workers (Step 98). If the user would like to configure the service requesters and pagers or change the relationship between service requesters and pagers or table assignments of workers (YES in Step 98), then a determination is made as to whether the user would like to make a permanent or temporary change (i.e., is this change to be made only for a short period of time or is this to be a permanent change due to changes in staffing) (Step 100). If the user wants to only make a temporary change (Temp in Step 100), then the system enables the authorized user to temporarily reassign the service requesters and pagers and groupings or relationships among service requesters and pagers (Step 102). If the change is to be permanent (Permanent in Step 100), then the system enables the authorized user to add, modify or delete service requesters and pagers, to add, modify or delete logical descriptions and groupings of service requesters and pagers, to add, modify or delete relationships between service requesters and pagers, logical descriptions, groupings of service requesters and pagers and time categories relating to the times during the day or a shift that the groupings are to occur (Step 104).

Returning to Step 98, if the user does not wish to configure the service requesters and pagers or change the relationships between the service requesters and pagers (NO in Step 98), then a determination is made as to whether the user would like to add, modify or delete users (i.e., employees who can access the system via the base station) (Step 106). If the user does wish to add, modify or delete users (YES in Step 106), then the system enables the authorized user to add, modify or delete user information including, but not limited to, the full name, short name, password and pager assignment (Step 108). If the user does not wish to add, modify or delete users (NO in Step 106), then a determination is made as to whether the user would like to add, modify or delete time categories (Step 110). If the user would like to add, modify or delete time categories (YES in Step 110), then the system enables the authorized user to add, modify or delete time information including, but not limited to, shift names and time ranges. If the user does not wish to add, modify or delete time categories (NO in Step 110), then a determination is made as to whether the user would like to view or extract service request reports (Step 114). If the user would like to view or extract service request reports (YES in Step 114), then the system enables the authorized user to view, extract, export, modify or delete information regarding the logging of service requests and any other recorded system information (Step 116). If the user does not wish to view or extract reports (NO in Step 114), then the method returns to (Step 90) wherein the system monitors the base station for input from a user.

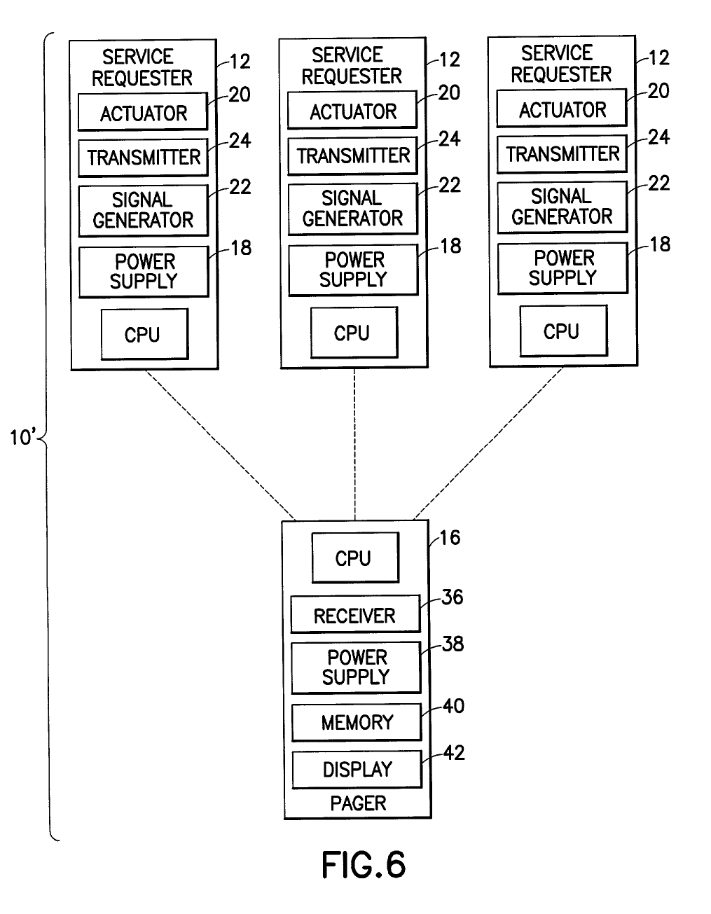

In an alternative embodiment of the invention as shown in FIG. 6, the service request communication system 10′ includes only a plurality of service requesters 12′ and a plurality of pagers 16′. Since the system shown in FIG. 6 does not include a base station, the allocation of service requesters to pagers is accomplished within the service requesters and pagers themselves as currently known in the art. It is foreseen that the information regarding service requests can be downloaded from each pager to a computer for analysis by management. The service requesters and pagers in FIG. 6 are shown as having CPU's for handling, among other things, the allocation of service requesters and pagers. While not shown, a CPU may also be included in the service requesters 12 and pagers 16 shown in FIG. 1.

The pagers used in the present claimed invention include a display for displaying a plurality of service requests received from the service requesters. In one embodiment, the display of the pager lists the service requests in chronological order of receipt. The display preferably identifies the time of actuation of the service requester (i.e., the time that the service request was made and that the signal was sent to the pager) and the current time. The display may also display the difference between the current time and the time that the service request was made.

The memory included within each pager stores each of the requests for service from the associated manually actuatable service requesters. The display may also display the current time so that a service provider can determine how much time has passed since the request was made. The pager is also configured to enable a service provider associated with a particular pager to note whether a service requester has sent more than one request for service within a predetermined time period. If two or more service requests have been made within a particular predetermined time period, then the service request may be given a higher priority. It is also foreseen that the pager can determine the difference in time between the current time and the time when the service request was made so that the service provider can easily determine how much time has elapsed since the request for service was made, and display this difference, so that the service provider will know how quickly they must respond to the request for service. It is also foreseen that each of the pagers provides an indication on the display as to which of the plurality of manually actuatable service requesters are currently associated with the corresponding pager.

In the preferred embodiment, the base station associates at least one of the plurality of manually actuatable service requesters with at least one of the plurality of pagers. It is also foreseen that the system can change the association of service requesters and pagers dynamically. For example, if a service provider needs to take a break during a shift, an authorized user provides this information to the base station and the base station will distribute the responsibility of the corresponding service requesters among the remaining service providers until the service provider returns. In addition, it is foreseen that if a high volume of requests are to be sent to a particular pager in a relatively short period of time and another pager has not received a large number of requests for service within the same period of time, the base station could direct one or more of the requests to the other pager.

As explained above, the system is designed such that if more than a predetermined number of requests for service are identified by the base station from a particular one of the plurality of manually actuatable service requesters within a predetermined time period, then a service request signal will not be sent from the base station to the corresponding one of the plurality of pagers. This is done so that in the event a customer or group of customers is merely playing with the service requester to have the service provider frequently come to the table. In this situation, the base station acts as a filter to prevent the multiple service requests from being passed on to the pager. As previously mentioned, the base station preferably includes a memory for storing each request for service by the plurality of manually actuatable service requesters so that this information can be accessed by management to determine whether there is a proper allocation of service providers and whether the service providers are being responsive to the customer requests.

Although the present invention is described with particular reference to its use in hospitality establishments such as restaurants, bars and the like, it is to be clearly understood that the invention is not limited to this particular application and that it is foreseen that the system can be applied to entertainment and sports venues such as concert halls and stadiums, hotels, and to retail establishments and warehouse type stores.

Although illustrative embodiments of the present invention have been described with reference to the accompanying drawings, it will be appreciated that the present invention is not limited to those precise embodiments and that various changes and modifications can be affected therein by one ordinary skill in the art without departing from the scope or spirit of the invention defined by the appended claims. For example, it is foreseen that the system could include multiple base stations and that a request for service as used in this application could be a request for a product, service and/or information by a customer. In addition, it is foreseen that instead of and/or in addition to utilizing pagers which are carried by the service providers, fixed remote communicators disposed at a central location or locations for the associated service providers can be utilized which display the requests (with priority) for multiple service providers.

What is claimed:

1. A customer activated device for use by a customer in an establishment to provide an indication to service personnel that the customer desires service, comprising:
a) a plurality of manually actuatable service requesters disposed at a plurality of locations within said establishment, each of the plurality of manually actuatable service requesters including a transmitter for transmitting at least one signal, specific to the corresponding service requester, upon actuation by a customer, corresponding to a request for service;
b) a base station including a receiver and transmitter, the base station being electrically coupled to each of the plurality of manually actuatable service requesters for receiving the electric signals transmitted by the manually actuatable service requesters and sending a service request signal in response thereto;
c) a plurality of remote communicators electrically coupled to the base station, each of the plurality of remote communicators being associated with at least one of the plurality of manually actuatable service requesters, and at least one of the plurality of remote communicators receiving the service request signal from the base station in response to actuation of a corresponding one of the plurality of manually actuatable service requesters, each of the plurality of remote communicators including a display for concurrently displaying a plurality of service requests;
wherein when a service request signal is received by one of the plurality of remote communicators, a service personnel associated with the corresponding remote communicator is made aware that service is requested by the corresponding one of the plurality of manually actuatable service requesters.

2. The customer activated device as defined in claim 1, wherein the display lists the service requests in at least one of chronological and priority order.

3. The customer activated device as defined in claim 2, wherein the display identifies the time of actuation of the corresponding one of the plurality of manually actuatable service requesters.

4. The customer activated device as defined in claim 1, wherein each of the plurality of remote communicators includes a memory for storing each of the requests for service from the corresponding manually actuatable service requesters and the time at which the request was made.

5. The customer activated device as defined in claim 1, wherein each of the plurality of remote communicators displays the current time.

6. The customer activated device as defined in claim 1, wherein each of the plurality of remote communicators is configured to enable service personnel associated with a particular pager to note whether a customer has made more than one request for service in a time period.

7. The customer activated device as defined in claim 1, wherein each of the plurality of remote communicators displays the time each request for service was made.

8. The customer activated device as defined in claim 1, wherein each of the plurality of remote communicators provides an indication of the difference between a current time and a time when a request for service was made.

9. The customer activated device according to claim 8, wherein the indication of the difference between the current time and a time when a request for service was made is the real time since the last request for service by the customer.

10. The customer activated device as defined in claim 1, wherein each of the plurality of remote communicators provides an indication as to which of the plurality of manually actuatable service requesters are associated with the corresponding remote communicators.

11. The customer activated device as defined in claim 1, wherein the base station associates at least one of the plurality of manually actuatable service requesters with at least one of the plurality of remote communicators.

12. The customer activated device as defined in claim 1, wherein if at least two requests for service are identified by the base station from a particular one of the plurality of manually actuatable service requesters within a predetermined time period, then a service request signal will not be displayed on the display of the corresponding one of the plurality of remote communicators.

13. The customer activated device as defined in claim 1, wherein if at least two requests for service are identified by the base station from a particular one of the plurality of manually actuatable service requesters within a predetermined time period, then a service request signal will be displayed on the corresponding one of the plurality of remote communicators with an indication of priority.

14. The customer activated device as defined by claim 13, wherein the indication of priority includes at least one of a flashing indicator, ordered listing, bolding on the display, indicative marking next to the corresponding service request on the display and italics of the corresponding service request on the display.

15. The customer activated device as defined in claim 1, wherein the base station includes a memory for storing the requests for service by each of the plurality of manually actuatable service requesters, the remote communicator being associated with the manually actuatable service requesters which requested service, and the time of the request for service.

16. The customer activated device as defined in claim 1, wherein the base station associates any of the plurality of manually actuatable service requesters with any of the plurality of remote communicators for said request for service.

17. The customer activated device according to claim 1, wherein the base station can dynamically change the association of each of the plurality of remote communicators with the plurality of manually actuatable service requesters, the dynamic change of association being performed for an individual remote communicator or manually actuatable service requester or a group of pagers or manually actuatable service requesters.

18. A customer activated device for use by a customer in an establishment to provide an indication to service personnel that the customer desires service, comprising:
a) a plurality of manually actuatable service requesters disposed at a plurality of locations within said establishment, each of the plurality of manually actuatable service requesters including a transmitter for transmitting a service request signal, specific to the corresponding service requester, upon actuation by a customer, said service request signal corresponding to a request for service; and
b) a plurality of remote communicators, each of the plurality of remote communicators being electrically coupled to and associated with at least one of the plurality of manually actuatable service requesters, and at least one of the plurality of remote communicators receiving the service request signal from at least one of the plurality of manually actuatable service requesters in response to actuation of a corresponding one of the plurality of manually actuatable service requesters, each of the plurality of remote communicators includes a display for concurrently displaying a plurality of service requests;
wherein when a service request signal is received by one of the plurality of remote communicators, a service personnel associated with the corresponding remote communicator is made aware that service is requested by the corresponding one of the plurality of manually actuatable service requesters.

19. The customer activated device as defined in claim 18, wherein the display lists the service requests in chronological order.

20. The customer activated device as defined in claim 19, wherein the display identifies the time of actuation of the corresponding one of the plurality of manually actuatable service requesters.

21. The customer activated device as defined in claim 18, wherein each of the plurality of remote communicators includes a memory for storing each of the requests for service from the corresponding manually actuatable service requesters and the time at which the request was made.

22. The customer activated device as defined in claim 18, wherein each of the plurality of remote communicators displays the current time.

23. The customer activated device as defined in claim 18, wherein each of the plurality of remote communicators is configured to enable service personnel associated with a particular remote communicator to note whether a customer has made more than one request for service in a time period.

24. The customer activated device as defined in claim 18, wherein each of the plurality of remote communicators displays the time each request for service was made.

25. The customer activated device as defined in claim 18, wherein each of the plurality of remote communicators provides an indication of the difference between a current time and the time when a request for service was made.

26. The customer activated device according to claim 25, wherein the indication of the difference between the current time and a time when a request for service was made is the real time since the last request for service by the customer.

27. The customer activated device as defined in claim 18, wherein each of the plurality of remote communicators provides an indication as to which of the plurality of manually actuatable service requesters are associated with the corresponding remote communicator.

28. The customer activated device as defined in claim 18, wherein if at least two requests for service are identified by a corresponding one of the plurality of remote communicators from a particular one of the plurality of manually actuatable service requesters within a predetermined time period, then a service request signal will not be displayed on the display of the corresponding one of the plurality of remote communicators.

29. The customer activated device as defined in claim 18, wherein if at least two requests for service are identified by a corresponding one of the plurality of remote communicators from a particular one of the plurality of manually actuatable service requesters within a predetermined time period, then a service request signal will not be displayed on the display of the corresponding one of the plurality of remote communicators with an indication of priority.

30. The customer activated device according to claim 29, wherein the indication of priority includes at least one of a flashing indicator, ordered listing, bolding on the display, asterisk next to the corresponding service request on the display and italics of the corresponding service request on the display.

31. The customer activated device as defined in claim 18, wherein any of the plurality of manually actuatable service requesters is associated with any of the plurality of remote communicators for said request for service.

32. The customer activated device according to claim 18, wherein each of the plurality of remote communicators is programmable by a user so as to be associated with any of the plurality of manually actuatable service requesters.

33. The customer activated device according to claim 18, wherein the association of each of the plurality of remote communicators with the plurality of manually actuatable service requesters is dynamically changeable, the dynamic change of association being performed for an individual remote communicator or manually actuatable service requester or a group of remote communicators or manually actuatable service requesters.
